(19) United States
(12) Patent Application Publication
(10) Pub. No.: US 2019/0210238 A1
(43) Pub. Date: Jul. 11, 2019

(54) FIBER SCRAP COLLECTOR FOR A FIBER CLEAVER AND A FIBER CLEAVER

(71) Applicant: INNO INSTRUMENT (CHINA) .INC, WeiHai (CN)

(72) Inventor: Yangri ZHAO, WeiHai (CN)

(21) Appl. No.: 16/115,384

(22) Filed: Aug. 28, 2018

(30) Foreign Application Priority Data
Jan. 10, 2018 (CN) 201810022959.3

(51) Int. Cl. B26D 7/18; B26D 7/26

(52) U.S. Cl. CPC B26D 7/1836; G02B 6/25; B26D 7/2628

(57) ABSTRACT

The present invention discloses a fiber scrap collector for a fiber cleaver and a fiber cleaver, which comprises a fiber cleaver main body and a collector, among which, the fiber cleaver main body comprises a fiber cleaver lid body which can be opened and closed and a movable blade holder; the blade holder carries a blade used to cleave fibers; the collector comprises a container box, an upper cover, an upper roller and a lower roller which can rotatably store fibers; and the upper roller is fixedly connected with the upper cover through an upper roller shaft. The fiber scrap collector provided in the present invention can improve the quality of fiber cleaving, thus improving the product quality and production efficiency. As a result, before the blade forms a cut on the fiber, the upper cover of the container is in an open state, and the fiber at the opening of the container is not clamped.

### CROSS-REFERENCE TO RELATED APPLICATIONS

This application claims the priority of Chinese Patent Application No. CN201810022959.3, filed on Jan. 10, 2018, the content of which is incorporated herein by reference in its entirety.

### TECHNICAL FIELD

The present invention relates to the field of fiber cutting equipment, and in particular, to a fiber scrap collector for a fiber cleaver.

### BACKGROUND

The fiber scrap collector is a device used in conjunction with the fiber cleaver main body to collect the fiber scraps left by the cleaver after cleaving fibers. The fiber scrap collector for the fiber cleaver can automatically get the fiber scraps left by the cleaver after cleaving fibers into a container box, thus being convenient to operate and avoiding environmental pollution at the same time. The applicant of the present application has disclosed a fully automatic fiber container in a patent under the number of CN201220210886.9, which can automatically store fiber scraps and solve the technical problem that fiber containers cannot recover long fiber scraps in the prior art. However, when the fiber container stores a fiber, the lid body of the fiber cleaver and the upper cover of the fiber container will clamp the two ends of the fiber first, then the blade of the fiber cleaver will cleave the fiber with a certain point in the middle of the clamping end as the cutting point, and the fiber scraps will be automatically got into the fiber container after the cleaving is completed. When the fiber cleaver is working, since both ends of the fiber have been clamped, the cleaving action will pull the fiber to a certain extent, resulting in uneven cleaving section of the fiber, thus the cleaving operation fails and it is necessary to re-prepare a fiber for re-cleaving. This reduces the utilization rate of the fiber and causes waste of the fiber, thereby increasing the cost, reducing the production efficiency and bringing a lot of inconvenience to the operator.

### SUMMARY

The problem to be solved by the present invention is to compensate for the above-mentioned drawbacks of the prior art, and to provide a fiber scrap collector for a fiber cleaver, which enables the upper cover of a container to be in an open state before a blade forms a cut on the fiber and does not clamp the fiber at the opening of the fiber collector.

The technical problem of the invention can be solved by the following technical proposals:

A fiber scrap collector for a fiber cleaver comprises a fiber cleaver main body and a fiber scrap collector, among which, the said fiber cleaver main body comprises a fiber cleaver lid body which can be opened and closed and a movable blade holder; the said blade holder carries a blade used to cleave fibers; the said collector comprises a container box, an upper cover, an upper roller and a lower roller which can rotatably store fibers; and the said upper roller is fixedly connected with the said upper cover through an upper roller shaft.

The said collector comprises a supporting lever for supporting the opening and closing of the upper cover, a limiting device movably connected with the said supporting lever, and a releasing device and a slope part fixedly connected with the said blade holder;

one end of the said supporting lever is in contact with the said upper cover, and the other end is in contact with the said slope part and can slide on the said slope part; the said releasing device is displaced along with the movement of the blade holder and touches the said limiting device during the said displacement process, and the said releasing device touches the said limiting device after the said blade cleaves fibers.

Further, the said supporting lever comprises a supporting lever groove and the said limiting device comprises a limiting projection; the said slope part comprises a slope highest part and a slope lowest part, and when the said supporting lever is slid to the said slope highest part, the said limiting projection can be clamped into the said supporting lever groove so that the said supporting lever position is limited.

Further, the said limiting device comprises a stopper fixedly connected with the said limiting projection, a limiting main body fixedly connected with the said stopper, and a limiting spring surrounding the outer side of the said limiting main body; the diameter of the said limiting spring is larger than that of the said limiting main body and smaller than that of the said stopper;

when the said releasing device touches the said limiting device along with the movement of the said blade holder, the said limiting spring is compressed to enable the said limiting projection to leave the said supporting lever groove.

Alternatively, the said limiting device comprises a limiting main body connected with the said limiting projection, and the material of the said limiting main body is deformable; when the said releasing device touches the said limiting device along with the movement of the said blade holder, the said limiting main body is deformed to enable the said limiting projection to leave the said supporting lever groove.

Further, the said blade holder is integrally formed with the said slope part, and the said releasing device is positioned above the plumb direction at the lowest part of the said slope.

Further, the said upper cover comprises an upper cover first projecting part; the top end of the said supporting lever is in contact with the said first projecting part, the other end of the said supporting lever is always in vertical contact with the said slope part, and the upper cover is opened or closed when the said supporting lever is positioned at the highest point of the said slope and the lowest point of the said slope.

Further, the said limiting device comprises a limiting fastener, and the said limiting fastener is fixedly connected with the said fiber cleaver main body, or fixedly connected with the said collector, to enable the said limiting device not to move along with the movement of the said blade holder.

Further, the said limiting device comprises a limiting clamp, and the said limiting main body comprises a limiting main body through hole for accommodating the said limiting clamp, wherein the said limiting main body is displaced in the said limiting main body through hole, and the displacement distance is limited by the said limiting clamp and the said stopper.

Further, the said limiting device comprises a limiting guide rod, wherein one end of the said limiting guide rod is fixedly connected with the said limiting fastener, and the other end is movably connected with the said stopper, so that the said stopper is only displaced in the axial direction of the said limiting guide rod.

Further, the said upper cover comprises an upper cover second projecting part and an upper cover spring, and the said upper cover second projecting part comprises a hook; one end of the said upper cover spring is connected with the said hook and the other end is connected with the said collector, and the tension of the said upper cover spring keeps the said upper cover in a closed state.

Further, the said collector comprises a rotating mechanism, wherein the said blade holder comprises a toothed gear; one end of the said rotating mechanism is connected with the said toothed gear, and the other end is connected with one of the said upper roller and the said lower roller;

the said toothed gear is displaced to drive the said rotating mechanism to rotate, thereby driving one of the said upper roller and the said lower roller to rotate.

Further, the said rotating mechanism comprises a first gear meshed with the said toothed gear, a second gear meshed with the said first gear, a gear lever and a third gear; the said second gear and the said third gear are respectively positioned at two ends of the said gear lever; the said third gear is a one-way bearing, and when the said first gear rotates, the said third gear rotates clockwise or anticlockwise only.

Further, the said rotating mechanism further comprises a first gear shaft and a second gear shaft; the said first gear shaft comprises a fourth gear meshed with the said third gear, the said second gear shaft comprises a fifth gear meshed with the said fourth gear, and a lower roller fixedly connected with the said second gear shaft, and the said lower roller rotates synchronously with the said fifth gear.

The invention also provides a fiber cleaver, which comprises a collector for recycling fiber scraps, and this collector is the above-mentioned fiber scrap collector for the fiber cleaver.

Due to the fit between the supporting lever and the limiting device, the upper cover of the fiber collector provided in this invention is in an open state when a fiber is cleave (before the blade forms a cut on the fiber), thus avoiding the problem of uneven cutting end surface caused by pulling caused by clamping one end of the fiber, effectively improving the cleaving quality of the fiber, and improving the production efficiency. And due to the arrangement of the upper cover spring, when the supporting lever no longer supports the upper cover to be in an open state after the cleaving operation is finished, the upper cover of the collector is closed, thus avoiding the problem that fiber scraps leak out and pollute the environment.

### BRIEF DESCRIPTION OF DRAWINGS

FIG. 1 is a schematic diagram of the overall structure of the fiber cleaver and the fiber collector according to the present invention;

FIG. 2 is an exploded view of the overall structure of the fiber scrap collector for the fiber cleaver according to the present invention;

FIG. 3 is a schematic diagram of the overall structure of the limiting device of the fiber scrap collector for the fiber cleaver according to the present invention;

FIG. 4 is a schematic position diagram of the core structure of the fiber scrap collector for the fiber cleaver in the initial state according to the present invention;

FIG. 5 is a schematic diagram of the limiting state of the limiting device of the fiber scrap collector for the fiber cleaver in the initial state according to the present invention;

FIG. 6 is a schematic position diagram of the core structure of the fiber scrap collector for the fiber cleaver in the finished state according to the present invention;

FIG. 7 is a schematic diagram of the release state of the releasing device of the fiber scrap collector for the fiber cleaver in the finished state according to the present invention;

FIG. 8 is a schematic diagram of the spring state of the fiber scrap collector for the fiber cleaver according to the present invention when the upper cover is opened in the initial state;

FIG. 9 is a schematic diagram of the spring state of the fiber scrap collector for the fiber cleaver according to the present invention when the upper cover is closed in the finished state;

FIG. 10 is a schematic diagram of the internal drive structure of the fiber scrap collector for the fiber cleaver in the initial state according to the present invention;

FIG. 11 is a schematic diagram of the internal drive structure of the fiber scrap collector for the fiber cleaver in the finished state according to the present invention.

### REFERENCE NUMBERS IN THE FIGURE

Fiber cleaver main body 1, fiber cleaver lid body 12, blade holder 13, toothed gear 131, blade 132, collector 2, container box 21, key 22, upper cover 23, upper roller 24, upper roller shaft 241, housing 25, housing chute 251, housing hole 252, upper cover first projecting part 231, upper cover second projecting part 232, hook 2321, upper cover spring 233, upper cover shaft hole 234, supporting lever 31, limiting device 32, releasing device 33, slope part 34, supporting lever groove 311, limiting spring 321, stopper 322, limiting projection 3222, limiting main body 323, limiting fastener 324, limiting guide rod 325, limiting clamp 326, guide hole 3221, limiting main body through hole 3231, connection 3241, limiting main body accommodating hole 3242, limiting guide accommodating hole 3243, slope highest point 341, slope lowest point 342, rotating mechanism 4, first gear 41, second gear 42, gear lever 43, third gear 44, fourth gear 45, fifth gear 46, lower roller 47, first gear engaging part 411, first gear bevel gear part 412, first gear shaft 451, second gear shaft 461.

### DETAILED DESCRIPTION OF EMBODIMENTS

Hereinafter, the present invention will be described further with reference to the preferred embodiments and with reference to the accompanying drawings.

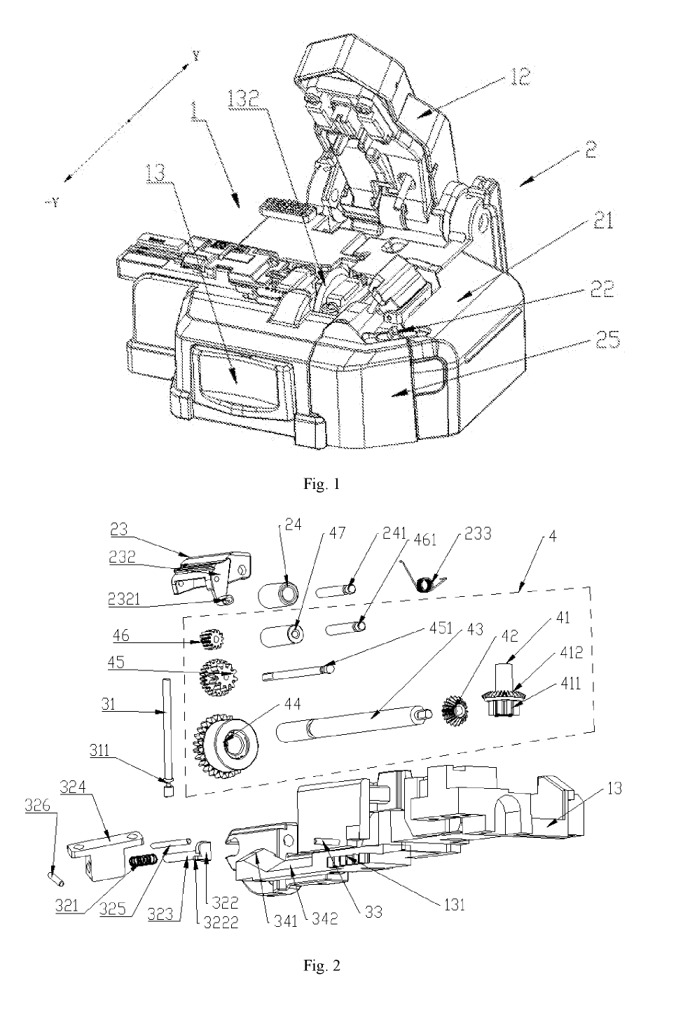

According to the reference to FIG. 1, a fiber scrap collector for a fiber cleaver provided in the present invention comprises a fiber cleaver main body 1 and a fiber scrap collector 2, among which, the said fiber cleaver main body 1 comprises a fiber cleaver lid body 12 which can be opened and closed and a movable blade holder 13; the said blade holder 13 carries a blade 132 used to cleave fibers. As shown in FIG. 1, the blade holder 13 can move along Y direction and Y-direction and cleave fibers during the movement. The inner and outer directions of the movement of the blade holder 13 in the present invention refer to: Y direction and −Y direction respectively.

The collector 2 provided in the present invention comprises a container box 21 for storing fiber scraps after cleaving, a key 22 for detachably connecting the container box 21 with the collector 2, and a housing 25, wherein the housing 25 is provided with a housing chute 251 and a housing hole 252.

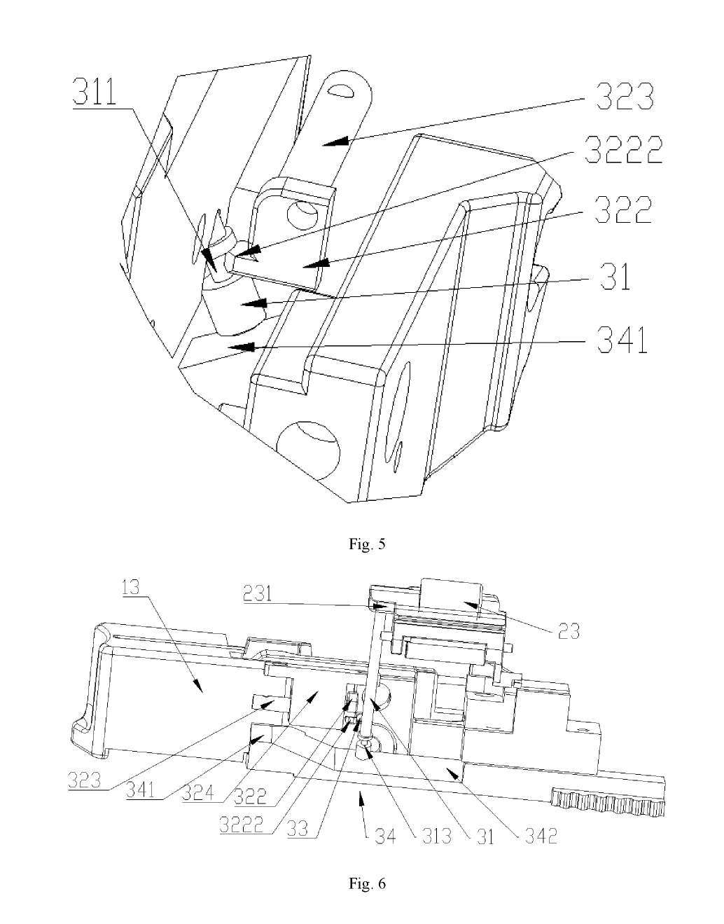

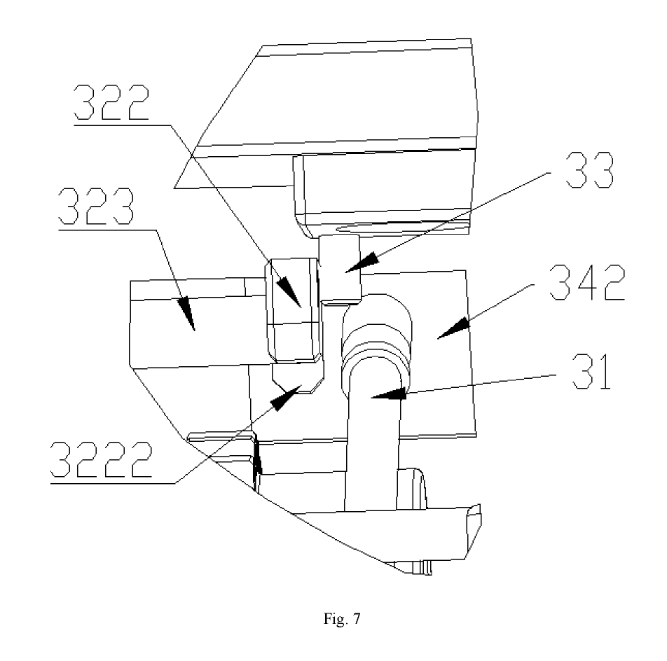

According to the reference to FIG. 2 through FIG. 11, the said collector 2 further comprises an upper cover 23, and an upper roller 24 and a lower roller 47 that can rotatably store fibers, among which, the said upper roller 24 is fixedly connected to the said upper cover 23 through an upper roller shaft 241.

The collector 2 further comprises a supporting lever 31 in contact with the upper cover 23 for supporting the upper cover 23 to be opened or closed, a limiting device 32 in fit with the supporting lever 31 to limit the position of the supporting lever 31, a releasing device 33 provided on the said blade holder 13 to release the limiting relationship between the said limiting device 32 and the supporting lever 31, a slope part 34 provided on the blade holder 13 to be connected with the other end of the supporting lever 31, and a rotating mechanism 4 to rotate the lower roller 47 with the movement of the blade holder 13.

One side of the upper cover 23 is provided with an upper cover first projecting part 231 in contact with the said supporting lever 31, the other side is provided with an upper cover second projecting part 232, the upper cover second projecting part 232 is provided with a hook 2321, the upper cover 23 is further provided with an upper cover spring 233 having one end connected with the hook 2321 and the other end connected with the housing hole 252 to keep the upper cover 23 in a closed state, and an upper cover shaft hole 234 accommodating the upper roller shaft 241.

The supporting lever 31 is provided with a supporting lever groove 311.

Preferably, the limiting device 32 comprises a deformable limiting spring 321, a stopper 322, a limiting main body 323 fixedly connected with the said stopper 322, a limiting fastener 324 for fixing the limiting device 32, a limiting guide rod 325 for guiding the stopper 322, and a limiting clamp 326 for limiting the displacement distance of the limiting main body 323. Among others, the stopper 322 is fixedly connected with a limiting projection 3222 which is matched with the shape of the supporting lever groove 311. Preferably, the limiting projection 3222 can be integrally formed with the stopper 322 and is a part of the stopper 322.

The said limiting projection 3222 can be clamped into the said supporting lever groove 311 so that the position of the said supporting lever 31 is limited.

The limiting fastener 324 comprises a connection 3241 fixedly connected with the fiber cleaver, a limiting main body accommodating hole 3242 accommodating the limiting main body 323, and a limiting guide accommodating hole 3243 accommodating the limiting guide rod 325.

The stopper 322 further comprises a guide hole 3221 for connecting the limiting guide rod 325.

The limiting main body 323 comprises a limiting main body through hole 3231 for accommodating the limiting clamp 326.

The slope part 34 is provided with a slope highest point 341 and a slope lowest point 342.

The rotation mechanism 4 comprises a first gear 41, a second gear 42, a gear lever 43, a one-way bearing third gear 44, a fourth gear 45, a fifth gear 46, a first gear shaft 451, and a second gear shaft 461.

The first gear 41 comprises a first gear engaging part 411 meshed with the blade holder 13 and a first gear bevel gear part 412 engaged with the second gear 42. The said second gear 42 and the said third gear 44 are respectively located at both ends of the said gear lever 43. The said first gear shaft 451 comprises a fourth gear 45 meshed with the said third gear 44. The said second gear shaft 461 is provided with a fifth gear 46 meshed with the said fourth gear 45 and a lower roller 47 sleeved on the second gear shaft 461.

In the drawings shown in the present invention, some of the drawings omit most of the structure of the blade holder 13 that is not related to the collector 2 of the present invention so as to more intuitively observe the collector 2.

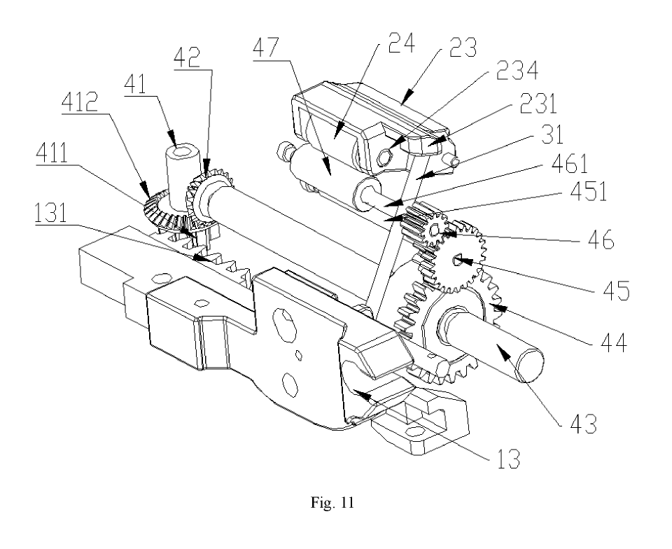

According to the reference to FIG. 10 and FIG. 11, the gear shaft of the first gear 41 is fixed to the fiber cleaver body 1 so that the first gear 41 can only rotate with the movement of the blade holder 13. On the other hand, the toothed gear 131 is fixed on the blade holder 13. When the blade holder 13 moves back and forth, the toothed gear 131 drives the first gear 41 to rotate clockwise or counterclockwise along with its forward or backward movement, thus driving the second gear 42 to rotate. The second gear 42 is fixed to one end of the gear lever 43, so when the second gear 42 rotates, the gear lever 43 rotates synchronously, thus driving the third gear 44 at the other end of the gear lever 43 to rotate. Since the third gear 44 is a one-way gear, the third gear 44 can only rotate in one direction, so that the fourth gear 45 meshed with the third gear 44 and the fifth gear 46 meshed with the fourth gear 45 can only rotate in one direction, and finally the fifth gear 46 and the lower roller 47 arranged on the second gear shaft 461 can only rotate in one direction.

When the upper roller 24 is in contact with the lower roller 47, the rotation of the lower roller 47 will drive the upper roller 24 to rotate, so that fiber scraps will be got into the collector 2 by the rotation of the lower roller 47 and the upper roller 24.

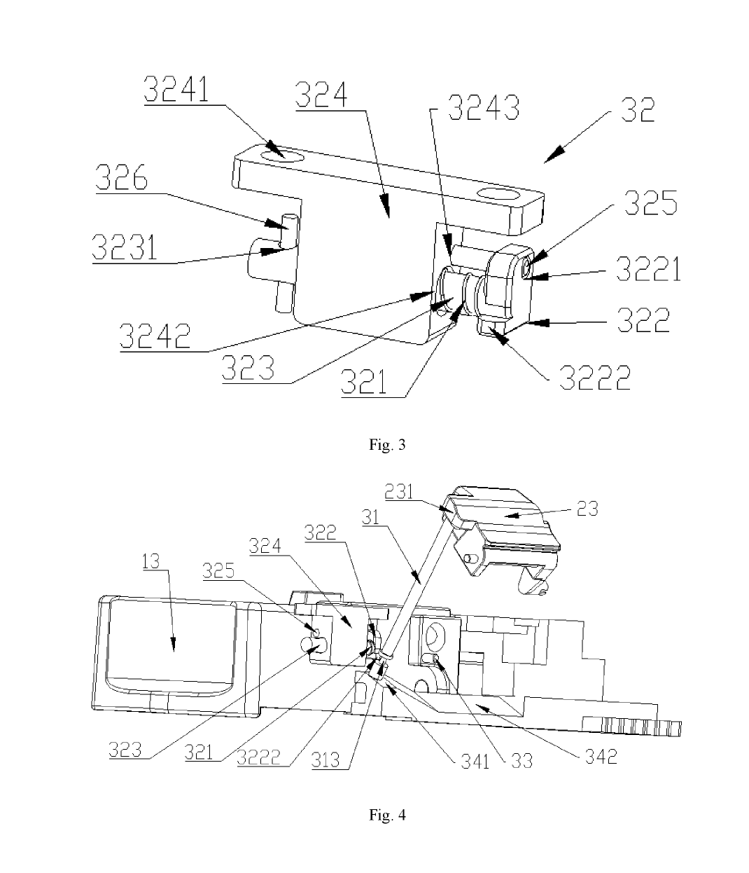

According to the reference to FIG. 3 through FIG. 7, the upper end of the supporting lever 31 is in contact with the upper cover first projecting part 231 of the upper cover 23, and the lower end is in contact with the slope part 34. When the lower end of the supporting lever 31 is located at the slope lowest point, the upper cover 23 is closed, and when the lower end of the supporting lever 31 is located at the slope highest point 341, the upper cover 23 is opened.

The said releasing device 33 is provided on the blade holder 13, and the position of the releasing device 33 is fixed above the plumb direction of the slope lowest point 342. In the invention, the releasing device 33 is a cylindrical projection protruding from the side wall of the blade holder 13, so that the releasing device 33 is in the same line with and can contact the limiting device 32 in the displacement direction of the blade holder 13. Furthermore, by setting the positions of the releasing device 33 and the limiting device 32, the contact between the releasing device 33 and the limiting device 32 is realized after the blade 132 cleaves the fiber. Preferably, in the present invention, the limiting device 32 is provided on the outermost side of the fiber cleaver main body 1, so that the releasing device 33 contacts the limiting device 32 as late as possible to ensure that the contact action between the releasing device 33 and the limiting device 32 occurs after the blade 132 cleaves the fiber. The present invention does not limit the shape of the releasing device 33, and shapes that can realize the function of the releasing device 33 are all within the scope of the present invention.

In this embodiment, the limiting device 32 is connected to the fiber cleaver body 1 so that the position of the limiting device 32 is fixed and does not move along with the movement of the blade holder 13. Of course, it is conceivable that when the limiting device 32 is connected to the collector 2, the limiting device 32 will not move along with the movement of the blade holder 13, so that the same technical effect can be achieved. The present invention will only be explained by taking the example of connecting the limiting device 32 to the fiber cleaver body 1, and the connection mode of the limiting device 32 to the collector 2 will not be described in detail here.

The limiting fastener 324 is provided with a connection 3241 connected to the fiber cleaver body 1. Preferably, screws (not shown in the figure) are threaded into the connection 3241 from bottom to top and then are locked to the fiber cleaver body 1, that is, the limiting fastener 324 is fixedly connected to the fiber cleaver body 1, and all other parts of the limiting device 32 are connected to the limiting fastener 324, so that the entire limiting device 32 is fixed in position.

The limiting main body 323 passes through the limiting main body accommodating hole 3242 on the limiting fastener 324 and both ends extend out of the limiting main body accommodating hole 3242. One end of the limiting main body 323 is provided with a stopper 322, and the other end is provided with a limiting main body through hole 3231 for accommodating the limiting clamp 326. The volume of the stopper 322 and the length of the limiting clamp 326 are both larger than the diameter of the limiting main body accommodating hole 3242, so that both ends of the limiting main body 323 have stoppers, and the limiting main body 323 will not fall off from the limiting main body accommodating hole 3242.

The limiting guide rod 325 passes through the limiting guide accommodating hole 3243 on the limiting fastener 324 that is in fit with the shape of the limiting guide rod 325, and one end of the limiting guide rod 325 is fixedly connected with the guide hole 3221 on the stopper 322. When the limiting main body 323 moves in the limiting main body accommodating hole 3242, the limiting guide rod 325 causes the limiting main body 323 to displace only in the axial direction of the limiting guide accommodating hole 3243.

The limiting spring 321 is sleeved outside the limiting main body 323 and its one end is accommodated at the end of the limiting main body accommodating hole 3242. Its diameter is larger than that of the limiting main body accommodating hole 3242, or larger than the inner diameter of the step in the limiting main body accommodating hole 3242. The diameter of its other end is smaller than the stopper 322, so that the position of the limiting spring 321 is fixed and can contract and relax with the movement of the limiting main body 323. When there is no external force, the limiting spring 323 is in a relaxed state. At this time, the limiting main body 323 is ejected out by the limiting spring 321, and the limiting clamp 326 prevents the limiting main body 323 from sliding out of the limiting main body accommodating hole 3242.

Of course, it is conceivable that when the material of the limiting main body 323 is deformable, the limiting main body 323 itself has the function of a limiting spring 321, and the limiting main body 323 can contract by touching or pressing the limiting main body 323. Therefore, the limiting spring 321 can be omitted at this time, and the deformable material can be silica gel or hard foam, etc. This scheme is also within the scope of the present invention and will not be described in detail here.

When the supporting lever 31 is located at the slope lowest point 342 of the slope part 34, the upper cover 23 is in a closed state, pushing the blade holder 13 to move the position of the blade holder 13, and the slope part 34 on the blade holder 13 also moves along with it. The bottom end of the supporting lever 31 slides from the slope lowest point 342 to the slope highest point 341, thus gradually opening the upper cover 23. When the blade holder 13 moves to the end, the supporting lever 31 reaches the slope highest point 341, and the upper cover 23 is fully opened. At this time, the limiting projection 3222 snaps into the supporting lever groove 311, and the position of the upper cover 23 is thus secured.

When the blade holder 13 is reset outward, the slope part 34 moves synchronously. At this time, since the limiting projection 3222 is snapped in the supporting lever groove 311, the upper cover 23 is always in an open state and its position will not change. After the blade 132 on the blade holder 13 cleaves the fiber, the releasing device 33 starts to touch the stopper 322 of the limiting device 32 and presses the stopper 322 along with the movement of the blade holder 13 to drive the limiting main body 323 to move in the limiting main body accommodating hole 3242. The limiting spring 321 is pressed and contracted, the limiting projection 3222 slides out of the supporting lever groove 311, the supporting lever 31 slides down to the slope lowest point 342 without support, and the upper cover 32 is closed accordingly.

When the blade holder 13 is pushed again, the releasing device 33 moves with the blade holder 13, the limiting device 32 is released, the limiting spring 321 relaxes in a natural state, and the limiting main body 323 and the stopper 322 are reset. With the movement of the blade holder 13, the bottom end of the supporting lever 31 again moves from the slope lowest point 342 to the slope highest point 341, thus gradually opening the upper cover 23 again. When the blade holder 13 again moves to the end, the supporting lever 31 reaches the slope highest point 341, and the upper cover 23 is fully opened. At this time, the limiting projection 3222 snaps into the supporting lever groove 311, and the position of the upper cover 23 is thus secured again.

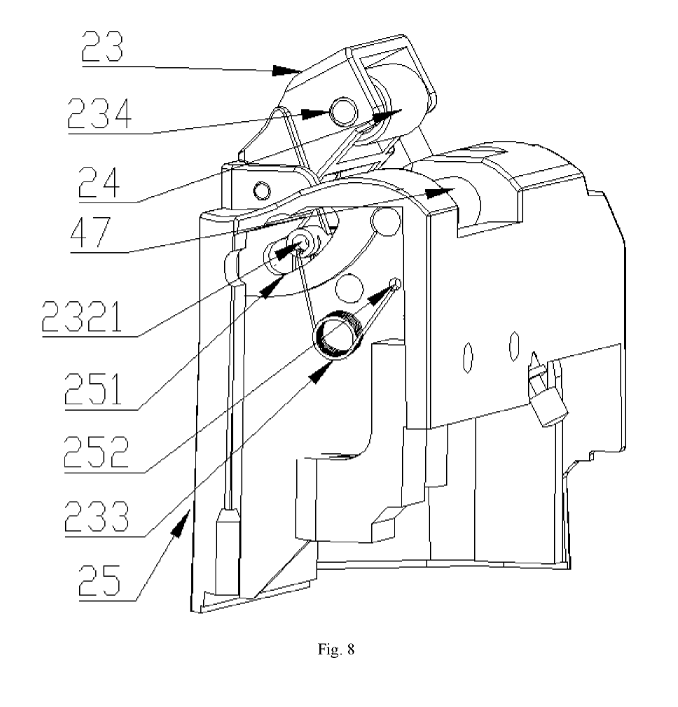

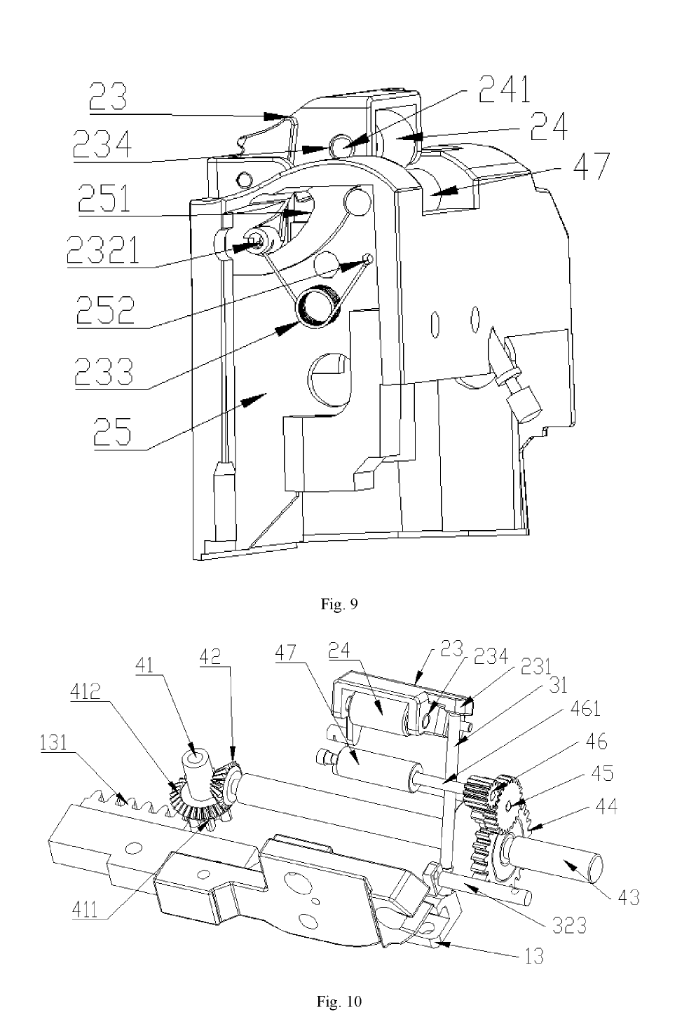

According to the reference to FIG. 2, FIG. 8 and FIG. 9, the housing 25 is provided with a housing hole 252 and a housing chute 251 for the hook 2321 to slide. The hook 2321 protrudes from the housing chute 251 and is fixedly connected with the upper cover spring 233. One end of the upper cover spring 233 is connected with the hook 2321 and the other end is connected with the housing hole 252. The tension of the upper cover spring 233 causes the hook 2321 to slide to the lowermost end of the housing chute 251 and drives the upper cover second projecting part 232 to generate a backward acting force, so that the upper cover 23 is kept in a closed state and does not open with changes in external position (such as inversion of the cleaver), thus avoiding the accidental falling out of the fiber scraps caused by the non-closure of the upper cover of the collector in the past. When the supporting lever 31 jacks up the first projecting part 231 of the upper cover due to the change of position, the upper cover projecting part 232 generates a forward acting force, thereby driving the hook 2321 to slide upward in the housing chute 251, so that the upper cover 23 is kept in a temporarily opened state.

According to the reference to FIG. 2 through FIG. 11, the fiber cleaver of the present invention has two states, namely the initial state and the finished state. Similarly, the fiber scrap collector for the fiber cleaver 2 according to the present invention also has two states. In the present invention, one complete fiber cleaving and fiber scrap recovery needs to undergo the transition from the initial state to the finished state to the initial state. Therefore, the two states of the fiber scrap collector for the fiber cleaver 22 according to the present invention, as well as the transition mode and the complete fiber cleaving and fiber scrap recovery are described in this embodiment.

Before use, the preliminary state of the fiber cleaver and the fiber scrap collector for the fiber cleaver 2 is the initial state, and the state in which the cleaving operation is finished and the blade holder 13 is ejected is the finished state.

In the initial state, the fiber cleaver lid body 12 is opened, the blade holder 13 has been pushed to the innermost side, the supporting lever 31 is located at the slope highest point 341, and the limiting projection 3222 of the limiting device 32 is clamped into the supporting lever groove 311, the limiting spring 321 relaxes, and the upper cover 23 of the collector 2 is opened and fixed in position.

At this time, the fiber is put into the fiber cleaver body 1, the fiber cleaver lid body 12 is closed and pressed, and the fiber cleaver and the collector 2 are converted from the initial state to the finished state. The blade holder 13 starts to move from inside to outside. The releasing device 33 moves synchronously with the blade holder 13. After the blade 132 on the blade holder 132 cleaves the fiber, the said releasing device 33 starts to touch the stopper 322 and continues to press the stopper 322 with the blade holder 13. The limiting spring 321 contracts, the limiting projection 3222 slides out of the supporting lever groove 311, the supporting lever 31 falls into the slope lowest part 342, and the upper cover 23 closes and clamps the fiber scraps after cleaving. The fiber cleaver and the fiber scrap collector for the fiber cleaver 2 reach the finished state.

The blade holder 13 is pushed again to change the fiber cleaver and the fiber scrap collector for the fiber cleaver 2 from the finished state to the initial state.

At this time, the toothed gear 131 on the blade holder 13 moves with the blade holder 13, driving the first gear 41 to rotate, thus driving the second gear 42 to rotate, and the gear lever 43 fixedly connected with the second gear 42 to rotate synchronously, thus causing the one-way gear third gear 44 on the other side of the gear lever 43 to rotate. The fourth gear 45 meshed with the third gear 44 and the fifth gear 46 meshed with the fourth gear 45 also rotate accordingly, and the lower roller 47 coaxial with the fifth gear 46 rotates synchronously, driving the upper roller 24 in contact with the lower roller 47 to rotate, thereby getting the fiber scraps into the collector 2.

While the supporting lever 31 moves along with the slope part 34 on the blade holder 13 and is gradually supported until the upper cover 23 is opened, the limiting projection 3222 is snapped in the supporting lever groove 311, the upper cover 23 is opened again and fixed in position, and the fiber cleaver and the fiber scrap collector for the fiber cleaver 2 enter the initial state again.

At this point, a complete fiber cleaving and fiber scrap recycling operation is finished, and the fiber cleaving and fiber scrap recycling can be repeated by repeating the above operations.

The above has been described in detail with respect to the specific embodiments of the present invention. It will be apparent to those skilled in the art that various modifications and adaptations may be made to the present invention without departing from the principles of the invention, which are also intended to be within the scope of the appended claims.

What is claimed is:

1. A fiber scrap collector for a fiber cleaver, comprising:
a fiber cleaver main body; and
a collector,
wherein:
the fiber cleaver main body comprises a fiber cleaver lid body capable of being opened and closed and a movable blade holder;
the blade holder carries a blade used to cleave fibers;
the collector comprises a container box, an upper cover, an upper roller and a lower roller which can rotatably store fibers; and the upper roller is fixedly connected with the upper cover through an upper roller shaft;
the collector further comprises a supporting lever for supporting the opening and closing of the upper cover, a limiting device movably connected with the supporting lever, and a releasing device and a slope part fixedly connected with the blade holder; and
one end of the supporting lever is in contact with the upper cover, and the other end is in contact with the slope part and can slide on the slope part; the releasing device is displaced along with the movement of the blade holder and touches the limiting device during the displacement process, and the releasing device touches the limiting device after the blade cleaves fibers.

2. A fiber scrap collector for a fiber cleaver according to claim 1, wherein:
the supporting lever comprises a supporting lever groove, and the limiting device comprises a limiting projection;
the slope part comprises a slope highest part and a slope lowest part, and when the supporting lever is slid to the slope highest part, the limiting projection is clamped into the supporting lever groove so that the supporting lever position is limited.

3. A fiber scrap collector for a fiber cleaver according to claim 2, wherein:
the limiting device comprises a stopper fixedly connected with the limiting projection, a limiting main body fixedly connected with the stopper, and a limiting spring surrounding the outer side of the limiting main body;
the diameter of the limiting spring is larger than that of the limiting main body and smaller than that of the stopper;
when the releasing device touches the limiting device along with the movement of the blade holder, the limiting spring is compressed to enable the limiting projection to leave the supporting lever groove.

4. A fiber scrap collector for a fiber cleaver according to claim 2, wherein:
the limiting device comprises a limiting main body fixedly connected with the limiting projection, and the material of the limiting main body is deformable;
when the releasing device touches the limiting device along with the movement of the blade holder, the limiting main body is deformed to enable the limiting projection to leave the supporting lever groove.

5. A fiber scrap collector for a fiber cleaver according to claim 3, wherein:
the blade holder is integrally formed with the slope part, and the releasing device is positioned above the plumb direction at the lowest part of the slope.

6. A fiber scrap collector for a fiber cleaver according to claim 5, wherein:
the upper cover comprises an upper cover first projecting part;
the top end of the supporting lever is in contact with the first projecting part, the other end of the supporting lever is always in vertical contact with the slope part, and the upper cover is opened or closed when the supporting lever is positioned at the highest point of the slope and the lowest point of the slope.

7. A fiber scrap collector for a fiber cleaver according to claim 6, wherein:
the limiting device comprises a limiting fastener, and the limiting fastener is fixedly connected with the fiber cleaver main body.

8. A fiber scrap collector for a fiber cleaver according to claim 6, wherein:
the limiting device comprises a limiting fastener, and the limiting fastener is fixedly connected with the collector.

9. A fiber scrap collector for a fiber cleaver according to claim 7, wherein:
the limiting device comprises a limiting clamp, and the limiting main body comprises a limiting main body through hole for accommodating the limiting clamp, wherein the limiting main body is displaced in the limiting main body through hole, and the displacement distance is limited by the limiting clamp and the stopper.

10. A fiber scrap collector for a fiber cleaver according to claim 9, wherein:
the limiting device comprises a limiting guide rod, wherein one end of the limiting guide rod is fixedly connected with the limiting fastener, and the other end is movably connected with the stopper, so that the stopper is only displaced in the axial direction of the limiting guide rod.

11. A fiber scrap collector for a fiber cleaver according to claim 10, wherein:
the upper cover comprises an upper cover second projecting part and an upper cover spring, and the upper cover second projecting part comprises a hook;
one end of the upper cover spring is connected with the hook and the other end is connected with the collector, and the tension of the upper cover spring keeps the upper cover in a closed state.

12. A fiber scrap collector for a fiber cleaver according to claim 1, wherein:
the collector comprises a rotating mechanism, wherein the blade holder comprises a toothed gear;
one end of the rotating mechanism is connected with the toothed gear, and the other end is connected with one of the upper roller and the lower roller;
the toothed gear is displaced to drive the rotating mechanism to rotate, thereby driving one of the upper roller and the lower roller to rotate.

13. A fiber scrap collector for a fiber cleaver according to claim 12, wherein:
the rotating mechanism comprises a first gear meshed with the toothed gear, a second gear meshed with the first gear, a gear lever and a third gear, wherein the second gear and the third gear are respectively positioned at two ends of the gear lever; the third gear is a one-way bearing, and when the first gear rotates, the third gear only rotates in one way.

14. A fiber scrap collector for a fiber cleaver according to claim 13, wherein:
the rotating mechanism further comprises a first gear shaft and a second gear shaft;
the first gear shaft comprises a fourth gear meshed with the third gear,
the second gear shaft comprises a fifth gear meshed with the fourth gear, and a lower roller fixedly connected with the second gear shaft, and the lower roller rotates synchronously with the fifth gear.

15. A fiber cleaver comprising a fiber scrap collector according to claim 1.
